(19) United States
(12) Patent Application Publication
(10) Pub. No.: US 2015/0230080 A1
(43) Pub. Date: Aug. 13, 2015

(54) MEDIA SCANNING METHOD AND MEDIA SCANNING TERMINAL

(71) Applicant: PANTECH CO., LTD., Seoul (KR)

(72) Inventor: Se Moon PARK, Seoul (KR)

(73) Assignee: PANTECH CO., LTD., Seoul (KR)

(21) Appl. No.: 14/177,752

(22) Filed: Feb. 11, 2014

(51) Int. Cl. H04W 8/22; G06F 9/44

(52) U.S. Cl. CPC H04W 8/22; G06F 9/4401; H04W 88/02

(57) ABSTRACT

Provided are a media scanning method and device for a storage medium of a user terminal. The media scanning method includes: determining, when a terminal is booting, whether a storage medium of the terminal meets an execution condition for media scanning; and performing media scanning of a storage medium when the determining determines that the execution condition for media scanning for the storage medium is met.

### CROSS-REFERENCE TO RELATED APPLICATION

This application claims priority from and the benefit under 35 U.S.C. §119(a) of Korean Patent Application No. 10-2013-0019078, filed on Feb. 22, 2013, which is hereby incorporated in its entirety by reference for all purposes as if fully set forth herein.

### BACKGROUND

1. Field

Exemplary embodiments of the present invention relate to a media scanning method and a media scanning device, and more particularly, to a method and device for executing media scanning when media scanning is performed during booting of a user terminal.

2. Discussion of the Background

Smart phones have been generalized and popularized and therefore are used for various uses in daily life. Capacity and size of files, such as, photo files, video files, and music files, being stored in a smart phone increase with use time of the smart phone. As the number of camera pixels for a user terminal increases and high quality audio files become more widespread, file storage for media files is being increased.

In general, a user of a smart phone reboots the smart phone at least once a day to replace a battery. Due to the size of files stored in the smart phone a large amount of time is taken to process media scanning that is executed every time the smart phone is rebooted. During the media scanning, the user has to wait until the media scanning is completed without doing other tasks.

Even if the media scanning is executed after booting of the smart phone is completed, since the media scanning is executed as soon as the booting starts, the user considers the media scanning time to be included in the boot time. As the media scanning time increases as the number of media files stored in the smart phone increases, the user may feel the boot time is longer.

Generally, a smart phone generates a media scanning result by executing media scanning with respect to all media files stored in all accessible memory, for example, an internal memory and an external memory, every time the smart phone is booted. The media scanning is executed by opening every object file to examine data. Here, not only the media files, such as, photo files and music files are opened, the media scanning also opens thumbnails and caches stored in the smart phone as they are considered objects of the media scanning. Therefore, time elapsed from start to end of the media scanning is increased.

In addition, although the media scanning is executed in a background, when a great number of files are to be scanned, utilization of a central processing unit (CPU) is increased. Therefore, other work may not be performed during the media scanning.

Accordingly, as the number of the media files stored in the smart phone increases, the time for completing the media scanning by accessing to various folders and files is increased. That is, an entire boot time of the smart phone is increased according to the increase in the media scanning time. Therefore, the user is inconvenienced while waiting for the boot time when using a device.

### BRIEF SUMMARY

Aspects of the present invention provide a media scanning method and a media scanning device.

Additional features of the invention will be set forth in the description that follows, and in part will be apparent from the description, or may be learned by practice of the invention.

According to exemplary embodiments of the present invention, there is provided a media scanning method including: determining, when a terminal is booting, whether a storage medium of the terminal meets an execution condition for media scanning; and performing media scanning of a storage medium when the determining determines that the execution condition for media scanning for the storage medium is met.

According to exemplary embodiments of the present invention, there is provided a media scanning terminal including: an execution condition determination unit configured to determine, when a terminal is booting, whether a storage medium of the terminal meets an execution condition for media scanning; and a media scanning unit configured to perform media scanning of the storage medium when the execution condition determination unit determines that the execution condition for media scanning for the storage medium is met.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a user terminal according to exemplary embodiments of the present invention.

FIG. 2 is a diagram illustrating a media scanning device according to exemplary embodiments of the present invention.

FIG. 3 is a diagram illustrating an initialization process of a framework of a mobile operation system (OS), according to exemplary embodiments of the present invention.

FIG. 4 is a diagram illustrating an implementation of a media scanning device, according to exemplary embodiments of the present invention.

FIG. 5 is a diagram illustrating a process of a media scanning device according to exemplary embodiments of the present invention.

FIG. 6 is a diagram illustrating a process of determining necessity of media scanning for an internal storage medium of a user terminal, according to exemplary embodiments of the present invention.

FIG. 7 is a diagram illustrating a process of determining necessity of media scanning for an external storage medium of a user terminal, according to exemplary embodiments of the present invention.

FIG. 8 is a diagram illustrating a process of determining validity of a media file, according to exemplary embodiments of the present invention.

FIG. 9 is a diagram illustrating a process of executing media scanning according to a mounting state of an external storage medium, according to exemplary embodiments of the present invention.

FIG. 10 is a diagram illustrating a process of media scanning according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Exemplary embodiments described in the specification are wholly hardware, and may be partially software or wholly software. In the specification, “unit”, “module”, “device”, “system”, or the like represents a computer related entity, such as, hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Hereinafter, exemplary embodiments will be described with reference to the accompanying drawings.

It will be understood that when an element is referred to as being “connected to” another element, it can be directly connected to the other element, or intervening elements may be present.

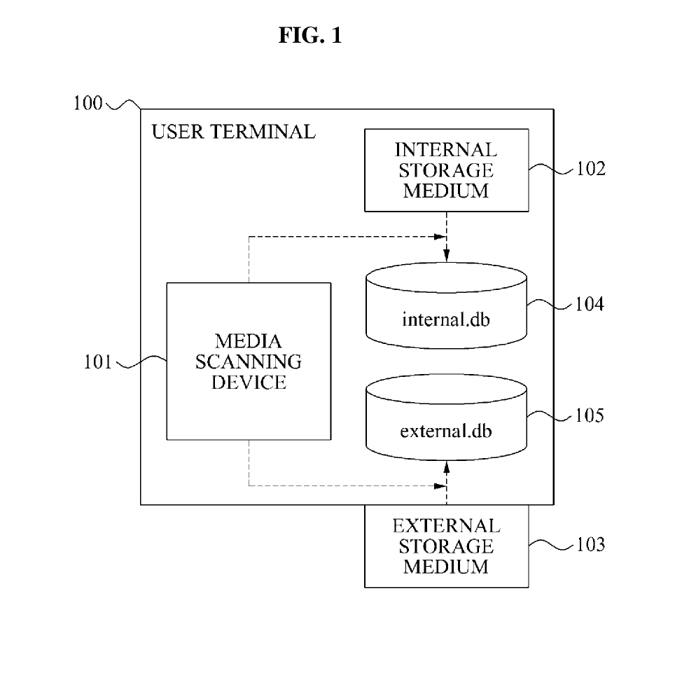

FIG. 1 is a diagram illustrating a user terminal according to exemplary embodiments of the present invention.

Referring to FIG. 1, a user terminal 100 may include a media scanning device 101, an internal storage medium 102, an external storage medium 103, an internal database (DB) internal.db 104, and an external DB external.db 105. The user terminal 100 may include various types of user terminals operated by a mobile operation system (OS), such as, a mobile phone, a smart phone, a tablet personal computer (PC), a notebook, a television (TV), and the like.

The internal storage medium 102, as a storage medium installed inside the user terminal 100, may include a non-volatile memory. The external storage medium 103, as a storage medium installed outside the user terminal 100, may include a non-volatile memory. The internal storage medium 102 may be inseparable with respect to the user terminal 100. The external storage medium 103 may be separable and connectable with respect to the user terminal 100. That is, depending on occasions, the external storage medium 103 may not be mounted to the user terminal 100.

The media scanning device 101 may scan media files stored in the internal storage medium 102 and store a scanning result in the internal.db 104. The internal.db 104 may be recorded in the form of a file in the internal storage medium 102 or a dedicated storage space. The media scanning device 101 may scan media files stored in the external storage medium 103 and store a scanning result in the external.db 105. The external.db 105 may be recorded in the form of a file in the internal storage medium 102 or a dedicated storage space. The media scanning device 101 may be implemented in the form of a separate module or chip or a processor in the user terminal 100.

According to exemplary embodiments, after the user terminal 100 is booted, the media scanning device 101 wholly scans the media files stored in the internal storage medium 102 and the external storage medium 103. However, to reduce a waiting time of a user after booting of the user terminal 100 when capacity or size of the media files increases, the media scanning device 101 may execute media scanning with respect to internal storage medium 102 and the external storage medium 103 only when the media scanning is necessary.

When media files are added, changed, or deleted in the internal storage medium 102 and the external storage medium 103 through an application during operation of the user terminal 100, the media scanning device 101 may scan an updated part of the media files in the internal storage medium 102 and the external storage medium 103. Here, the media scanning may refer to not partial scanning but entire scanning.

Hereinafter, operation of the media scanning device 101 will be described in detail.

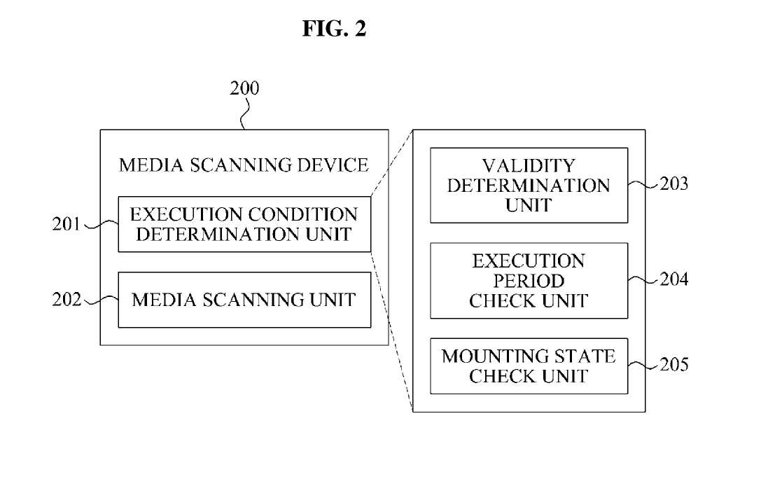

FIG. 2 is a diagram illustrating a media scanning device according to exemplary embodiments of the present invention.

Referring to FIG. 2, the media scanning device 200 may include an execution condition determination unit 201 and a media scanning unit 202. The execution condition determination unit 201 may include a validity determination unit 203, an execution period check unit 204, and a mounting state check unit 205.

When the user terminal is booted, the execution condition determination unit 201 may determine whether a storage medium of the user terminal meets execution conditions of media scanning. The storage medium may include an internal storage medium or an external storage medium of the user terminal. The media scanning may refer to a process in which an application operating in the user terminal checks attributes, such as, a file size, a file structure or directory, a folder, a generation date, and a name, of various files, such as, music, video, cookie, and text, stored in the internal or the external storage of the user terminal, and the application stores the checked information in the form of a library in a dedicated DB file.

For example, the internal storage medium may be available to the user terminal whereas the external storage medium may or may not be available to the user terminal. Availability of the external storage medium may be determined or selected by a user.

For example, the execution condition determination unit 201 may determine validity of media files related to the internal storage medium disposed in the user terminal. Here, the execution condition determination unit 201 may determine the validity by distinguishing whether the user terminal is normally or abnormally powered before booting. In addition, the execution condition determination unit 201 may determine the validity using a distinguishing value indicating a change state of a DB file related to the internal storage medium and a generation date of the DB file related to the internal storage medium.

According to exemplary embodiments, when the user terminal is abnormally powered off, the execution condition determination unit 201 may determine that the validity of the media file is abnormal. For example, when the user terminal is unexpectedly powered off due to sudden separation of the battery or full discharge of the battery, rather than by a normal termination process, a process of generating a distinguishing value related to the media file or generating a generation date of the DB file is not passed through the reboot. Therefore, when the user terminal is abnormally powered off, the execution condition determination unit 201 may determine the validity of the media file to be abnormal without a dedicated checking process.

According to exemplary embodiments, when the user terminal is normally powered off, the execution condition determination unit 201 may determine the validity of the media file using the distinguishing value indicating the change state of the DB file related to the internal storage medium and the generation date of the DB file related to the internal storage medium. Here, the distinguishing value may be used to check a change degree of the DB file before and after booting of the user terminal.

For example, the distinguishing value may be determined based on a size, a number, and a file structure or directory of the media file. According to exemplary embodiments, when a storing capacity of the total capacity of the internal storage medium is changed before and after the booting, the distinguishing value may be changed by as much as the change in the storing capacity between the booting. When the total number of files in the internal storage medium is changed before and after the booting, the distinguishing value may be changed by a changed number of the files. In addition, when the file structure is changed before and after the booting due to events, such as, file structure generation, name change, deletion, movement, and the like of folders in the internal storage medium of the user terminal, the distinguishing value may be changed by a number of changes of the file structure before and after the booting.

For example, the distinguishing value may include a Cyclic Redundancy Check (CRC) checksum calculated through, for example, a CRC 32 calculation application programming interface (API) provided by JAVA.

When the distinguishing value or the generation date of the internal DB file is changed before and after the boot, the execution condition determination unit 201 may determine the validity of the media file to be abnormal.

In addition, the execution condition determination unit 201 may check an execution period of media scanning of the internal storage medium. For example, the boot determination unit 201 may compare the execution period of media scanning of the internal storage medium with a scanning period. According to exemplary embodiments, the execution condition determination unit 201 may compare the scanning period with the execution period of media scanning to obtain a difference between a date of booting and a latest date of executing media scanning. The scanning period may be a minimum scanning period.

The scanning period may be changed to a period desired by the user through an interface. The execution condition determination unit 201 may control the scanning period according to at least one condition, such as, an application processing log related to generation, change and deletion of a media file, a media file transmission log with respect to another terminal, a download log of the media file through an external service, a total capacity of the internal storage medium, and a number of directories of the internal storage medium.

For example, when an application processing log related to generation, change and deletion of the media file, a media file transmission log with respect to another terminal, or a download log of a media file through an external service, is generated at least a control number of times, the execution condition determination unit 201 may control the scanning period to be short. In addition, when the total capacity of the internal storage medium is greater than a reference capacity or when the number of directories of the internal storage medium is greater than a control number, the scanning period may be controlled to be short.

As will be described hereinafter, the media scanning unit 202 executes media scanning when the execution period of media scanning of the internal storage medium is longer than the scanning period. Therefore, the media scanning unit 202 may increase probability of executing media scanning by reducing the scanning period according to particular circumstances.

When the validity of the media file stored in the internal storage medium is abnormal, the media scanning unit 202 may execute media scanning with respect to an entire region of the internal storage medium. When the execution period of media scanning of the internal storage medium is equal to or shorter than the scanning period, the media scanning unit 202 may not execute media scanning with respect to the entire region of the internal storage medium. According to exemplary embodiments, when the execution period of media scanning of the internal storage medium is longer than the scanning period, the media scanning unit 202 may execute media scanning with respect to the entire region of the internal storage medium.

A description about the internal storage medium may be applied in the same manner to the external storage medium.

For example, the execution condition determination unit 201 may determine validity of the media file related to an external storage medium that is removable from the user terminal. The execution condition determination unit 201 may determine the validity of the media file by distinguishing whether the user terminal is normally or abnormally powered off before booting. The execution condition determination unit 201 may determine the validity using a distinguishing value indicating a change state of a DB file related to the external storage medium and a generation date of the DB file related to the external storage medium.

When the user terminal is normally powered off, this may mean that the user requests termination or shutdown of the user terminal through the user terminal and accordingly the user terminal is powered off through a normal process. For example, the user terminal may be normally powered off when the user presses a power button for a control time. Abnormal powering off of the user terminal may happen when the user powers off the user terminal without a normal termination process, for example, by interrupting power connected to the user terminal (for example, by removing a battery) without a system alert.

According to exemplary embodiments, when the user terminal is abnormally powered off, the execution condition determination unit 201 may determine that the validity of the media file to be abnormal because when the user terminal was unexpectedly powered off due to separation of the battery or a full discharge of the battery, rather than by a normal termination process. As such, a process of generating a distinguishing value related to the media file or generating a generation date of the DB file is not passed through. Therefore, when the user terminal is abnormally powered off, the execution condition determination unit 201 may determine the validity of the media file to be abnormal without a dedicated checking process, or by the absence of the distinguishing value.

According to exemplary embodiments, when the user terminal is normally powered off, the execution condition determination unit 201 may determine the validity of the media file using the distinguishing value indicating the change state of the DB file related to the external storage medium and the generation date of the DB file related to the external storage medium. Here, the distinguishing value may be used to check a change degree of the DB file before and after booting of the user terminal.

For example, the distinguishing value may be determined based on a size, a number, and a file structure or directory of the media file. For example, when a storing capacity of the total capacity of the external storage medium is changed before and after the booting, the distinguishing value may be changed by as much as a change in the storing capacity between the booting. When the total number of files in the external storage medium is changed before and after the booting, the distinguishing value may be changed by a changed number of the files. In addition, when the file structure is changed before and after the booting due to generation, name change, deletion, movement, and the like of folders in the internal storage medium of the user terminal, the distinguishing value may be changed by a number of changes of the file structure before and after the booting.

For example, the distinguishing value may include a CRC checksum calculated through, for example, a CRC 32 calculation API provided by JAVA.

When the distinguishing value or the generation date of the external DB file is changed before and after the boot, the execution condition determination unit 201 may determine the validity of the media file to be abnormal.

In addition, the execution condition determination unit 201 may check an execution period of media scanning of the external storage medium. For example, the boot determination unit 201 may compare the execution period of media scanning of the external storage medium with a scanning period. In detail, the execution condition determination unit 201 may compare the scanning period with the execution period of media scanning, to calculate a difference between a date of booting and a latest date of executing media scanning for the external storage medium.

The scanning period may be changed to a period desired by the user through an interface. The execution condition determination unit 201 may control the scanning period according to at least one condition among, such as, an application processing log related to generation, change, and deletion of a media file, a media file transmission log with respect to another terminal, a download log of a media file through an external service, a total capacity of the external storage medium, and a number of directories of the external storage medium.

For example, when an application processing log related to generation, change, and deletion of the media file, a media file transmission log with respect to another terminal, or a download log of a media file through the external service is generated at least a control number of times, the execution condition determination unit 201 may control the scanning period to be short. In addition, when the total capacity of the external storage medium is greater than a reference capacity or when the number of directories of the internal storage medium is greater than a control number, the scanning period may be controlled to be short.

As will be described hereinafter, the media scanning unit 202 executes media scanning when the execution period of media scanning of the external storage medium is longer than the scanning period. Therefore, the media scanning unit 202 may increase probability of executing media scanning by reducing the scanning period according to particular circumstances.

The execution condition determination unit 201 may check a mounting state of the external storage medium based on a boot time point of the user terminal. The execution condition determination unit 201 may determine whether the external storage medium is mounted after booting of the user terminal. That is, the execution condition determination unit 201 may compare the mounting state of the external storage medium before and after the booting.

When the validity of the media file stored in the external storage medium is abnormal, the media scanning unit 202 may execute media scanning with respect to an entire region of the external storage medium. When the execution period of media scanning of the external storage medium is equal to or shorter than the scanning period, the media scanning unit 202 may not execute media scanning with respect to the entire region of the external storage medium. According to exemplary embodiments, when the execution period of media scanning of the external storage medium is longer than the scanning period, the media scanning unit 202 may execute media scanning with respect to the entire region of the external storage medium.

When the external storage medium is not mounted before the booting but is mounted after the booting, or when the external storage medium is dismounted and then remounted after the booting, the media scanning unit 202 may execute media scanning. When the external storage medium mounted before the booting is different from the external storage medium after the booting, the media scanning unit 202 may perform media scanning with respect to the external storage medium mounted after the booting.

According to exemplary embodiments, the user may prevent media scanning by controlling files stored in the internal storage medium, the external storage medium or by dedicatedly setting an operation about media scanning. For example, the user may designate a particular folder in which media scanning is not to be executed, with respect to the internal storage medium or the external storage medium, and insert files not requiring media scanning. In addition, the user may additionally assign particular marks to the files not requiring media scanning with respect to the internal storage medium or the external storage medium. In addition, the user may set prevention of media scanning with respect to the internal storage medium or the external storage medium irrespective of the validity, the execution period, and the mounting state, and may control media scanning to be executed as desired when necessary. Therefore, the media scanning unit 202 may control media scanning in consideration of user controls.

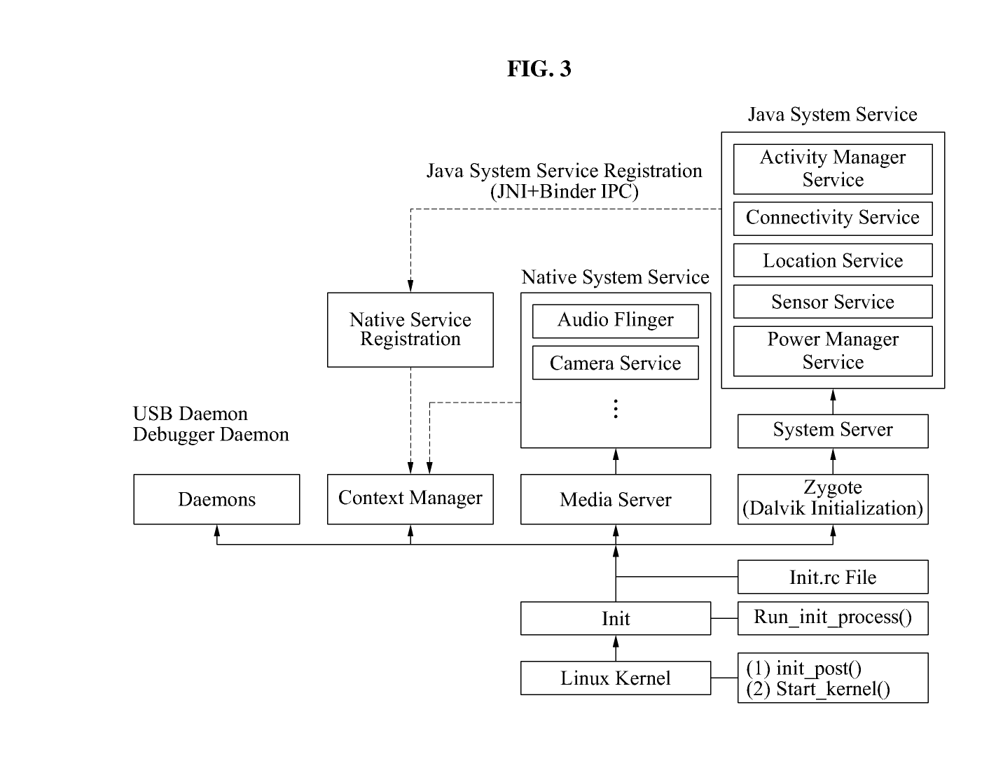

FIG. 3 is a diagram illustrating an initialization process of a framework of a mobile Operation System (OS), according to exemplary embodiments of the present invention.

FIG. 3 shows an operational process of booting a user terminal including the mobile OS. An ANDROID based OS is illustrated as the mobile OS in FIG. by way of example; other OSs with the same technical aspect may be utilized.

Exemplary embodiments may be applied when the user terminal includes an internal storage medium such as a memory or an external storage medium is additionally mounted. Exemplary embodiments may be applied in an environment where various attributes related to media files stored in the internal storage medium or the external storage medium are scanned after booting of the mobile OS and a scanning result may be stored in a dedicated DB file.

Since the ANDROID is a LINUX based platform, when the user terminal is booted, a LINUX kernel is operated through a boot loader. When the LINUX kernel is started, an initialization process usually named “init” process is called. The init process initializes various devices and executes various daemons, context managers, media servers, and Zygote necessary for operations of a framework.

The context manager is usually a main process managing a system service of the ANDROID. The system service may provide an important API necessary for processing a camera, audio, and video to production of various applications.

The media server may manage audio output or execute a native system service, such as, a camera service. The Zygote is usually a process for reducing a loading time of an ANDROID application. All types of JAVA-based application may operate on a process forked by the Zygote.

The system server is usually an ANDROID application process first forked from the Zygote and executed. The system server may execute JAVA system services, such as, an activity manager service or a location manager service. After all JAVA system services have been loaded, the activity manager service executes a home application, as part of booting.

According to exemplary embodiments, a media server, executed after booting of the user terminal, may operate a media scanner that is adapted to scan media files stored in the internal or external storage medium of the user terminal. A media scanning device may correspond to a media server executed during booting. When a control execution condition of media scanning is met or satisfied after booting, the media scanning device may scan media files stored in the internal storage medium or the external storage medium through the media scanner.

The execution condition of media scanning may include validity of the media file an execution period of media scanning, and a mounting state of the external storage medium. Depending on circumstances, media scanning may be performed with respect to a partial region changed before and after booting rather than an entire region of the internal storage medium or the external storage medium. Therefore, an actual waiting time including in a boot time caused due to media scanning may be reduced.

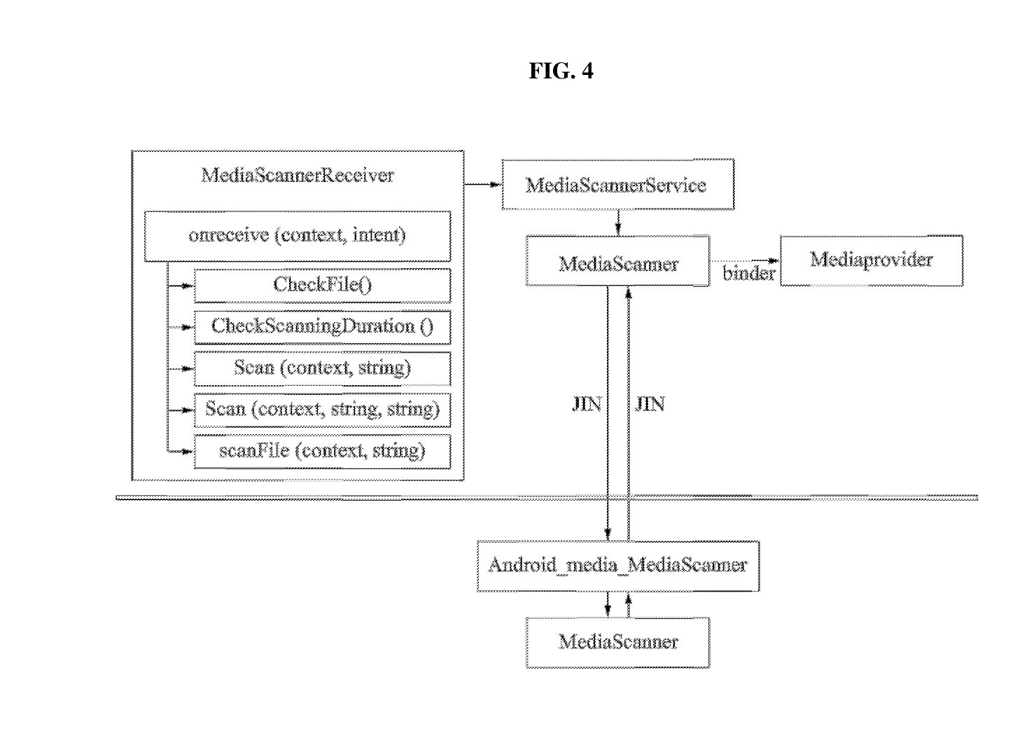

FIG. 4 is a diagram illustrating an implementation of a media scanning device, according to exemplary embodiments of the present invention.

When the user terminal is booted through a mobile OS, the media scanning device may identify the media files stored in the internal storage medium or the external storage medium by scanning the media files. When media scanning is thus completed, attributes of the media files identified through media scanning are stored in a dedicated DB. An application operated after booting may access the DB, for example, with an API in a library, and read files.

Media scanning performed along with booting may be executed with respect to the entire region of the internal storage medium or the external storage medium as entire scanning. According to exemplary embodiments, when media scanning is executed with respect to the entire region of the internal storage medium or the external storage medium, the user feels the boot time is increased due to the media scanning time, and the media scanning device may execute media scanning in the entire region or the partial region of the internal storage medium or the external storage medium when the control execution conditions are met.

Media scanning may be executed, when the system is first booted, when a file system storing the media file is accessed or when a library is constructed by scanning media files stored in a storage medium.

For example, when the mobile OS is based on the ANDROID, media scanning may be executed in the following exemplary process.

Media scanning may begin in MediaScannerReceiver through an onReceive( ) function. MediaScannerReceiver may react to intents, such as, ACTION_BOOT_COMPLETED, ACTION_MEDIA_MOUNTED, and ACTION_MEDIA_SCANNER_FILE. Here, ACTION_BOOT_COMPLETED may be broadcast one time after the user terminal is booted. ACTION_MEDIA_MOUNTED may be broadcast when an external storage medium is mounted to the user terminal. ACTION_MEDIA_SCANNER_FILE may be added to a DB after a media scanner scans a corresponding file. Since media scanning requires a processing time, actual processing may be performed in MediaScannerReceiver.

MediaScannerReceiver may produce or utilize an object called MediaScanner. MediaScanner may arrange information on a media file obtained by media scanning in a DB using a media DB called MediaProvider. In addition, MediaScanner may extract the information on the media file. The foregoing operations may be performed every time information on one media file is obtained. After media scanning is completed, Database (external.db and internal.db) including information on all media files stored in the internal storage medium and the external storage medium of the user terminal may be acquired. Therefore, an application, such as, Gallery may provide a preview function and the like using Database during a content view operation.

According to exemplary embodiments, prior to process the intents, a procedure, e.g., CheckFileQ, for checking validity of the media file stored in the internal storage medium and the external storage medium by comparing CRC Checksum or DB and a procedure, e.g., CheckScanningDurationQ, for checking an execution period of media scanning may be added. That is, whether media scanning is necessary since the media file is invalid or whether media scanning is necessary according to dates even if the media file is valid may be determined.

When media scanning is necessary afterwards, actual processing may be performed by MediaScannerService as aforementioned. MediaScannerService may produce or utilize the object called MediaScanner, and MediaScanner may record information on the media file obtained through media scanning using Media Database in a DB. Therefore, the information may be extracted from the DB afterward. When media scanning is determined to be unnecessary, a DB storing a result of previous media scanning may be used.

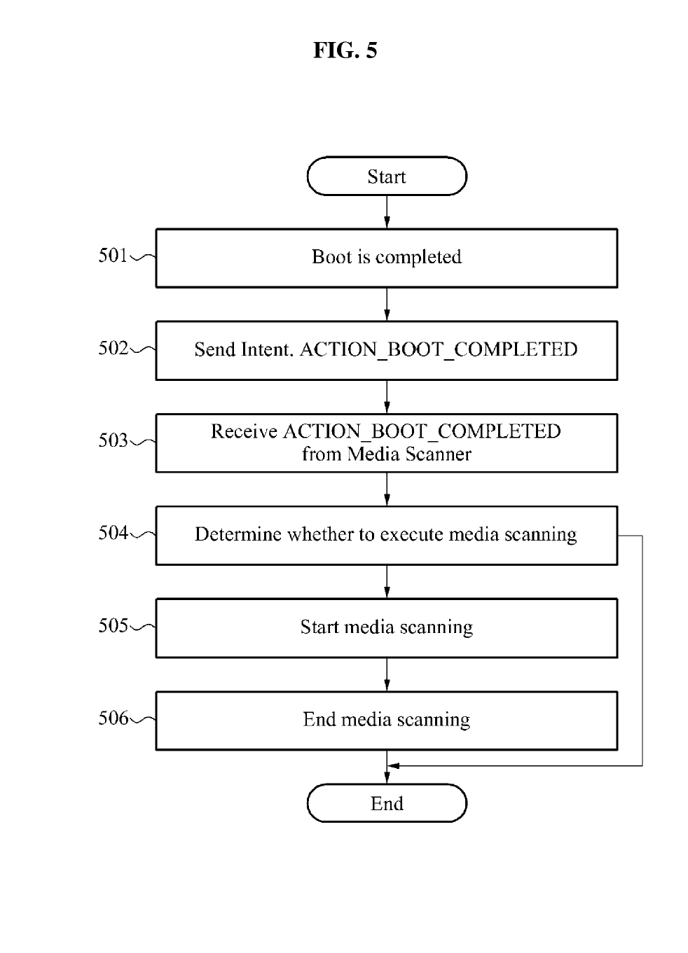

FIG. 5 is a diagram illustrating a of a media scanning device according to exemplary embodiments of the present invention.

When a processing command related to completion of booting of the user terminal reaches the media scanning device, the media scanning device may separately determine whether to execute media scanning and may execute media scanning.

Referring to FIG. 5, in operation 501, booting of the user terminal may be completed. Therefore, in operation 502, the processing command related to completion of booting of the user terminal may reach the media scanning device. For example, when the mobile OS is based on ANDROID, ACTION_BOOT_COMPLETED which is an intent related to completion of booting may be transmitted to MediaScanner corresponding to the media scanning device. In operation 503, the media scanning device may receive the processing command related to completion of booting. That is, MediaScanner may receive the intent related to completion of booting.

According to exemplary embodiments, the media scanning device may determine a necessity of media scanning of the internal storage medium or the external storage medium and may not execute media scanning right after receiving the process command.

According to exemplary embodiments, whether to execute media scanning may be determined according to validity of media files and an execution period of media scanning in relation to the internal storage medium. Also, in relation to the external storage medium, whether to execute media scanning may be determined according to the validity of the media files, the execution period of media scanning, and the mounting state of the external storage medium.

When media scanning with respect to the internal storage medium and the external storage medium is unnecessary, the media scanning device may be ended without executing media scanning. However, when media scanning is necessary, the media scanning device may start media scanning and end media scanning in operations 505 and 506, respectively. As media scanning is ended, a DB file Internal.db related to the internal storage medium and a DB file External.db related to the external storage medium may be generated.

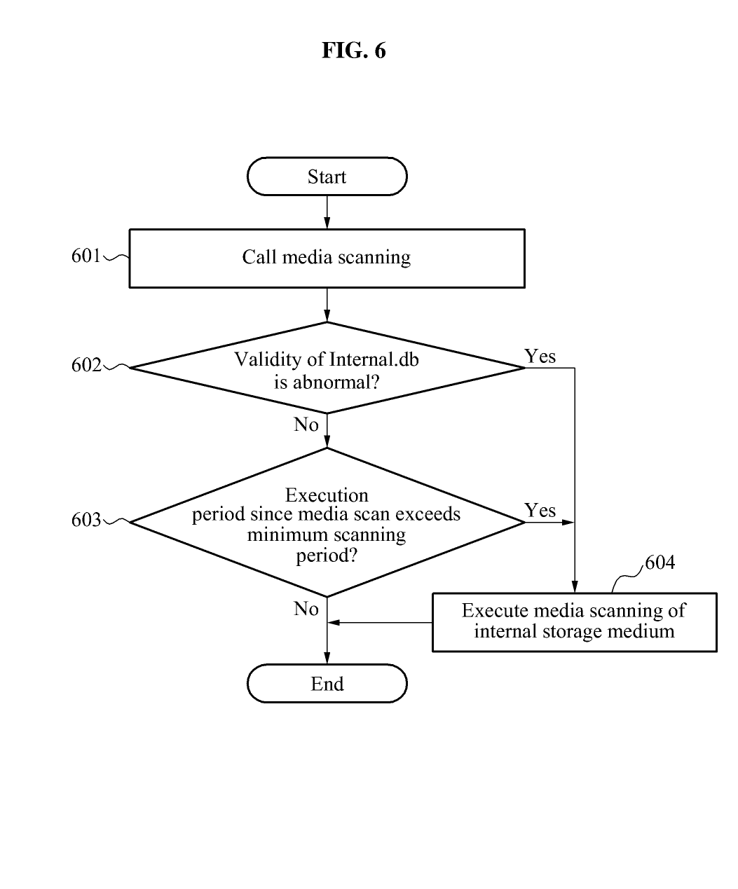

FIG. 6 is a diagram illustrating a process of determining necessity of media scanning of an internal storage medium of a user terminal, according to exemplary embodiments of the present invention.

In operation 601, the media scanning device may call media scanning. That is, the media scanning device may proceed with media scanning by calling media scanning.

In operation 602, the media scanning device may determine whether validity of Internal.db related to the internal storage medium is abnormal. According to exemplary embodiments, the media scanning device may determine validity of the media file using a distinguishing value indicating a change state of a DB file related to the internal storage medium and a generation date of the DB file related to the internal storage medium. When the validity of the Internal.db is abnormal, the media scanning device may execute media scanning of the internal storage medium in operation 604.

According to exemplary embodiments, when the validity of the Internal.db related to the internal storage medium is normal, the media scanning device may determine whether the execution period of media scanning exceeds a scanning period in operation 603. The execution period may refer to a difference between a current time at which booting is completed and a processing time of media scanning before booting.

When the execution period exceeds the scanning period, the media scanning device may execute media scanning of the internal storage medium in operation 604. When the execution period does not exceed the scanning period, the media scanning device may not execute media scanning of the internal storage medium.

In operation 603, when a difference between a current date and a latest date of executing media scanning is longer than the scanning period set by the user, the media scanning device may execute media scanning with respect to the entire region of the internal storage medium. According to exemplary embodiments, when the difference between the current date and the latest date of executing media scanning is equal to or shorter than the scanning period, the media scanning device may not execute media scanning.

That is, the media scanning device may execute media scanning when media scanning is necessary rather than every time booting is performed.

In addition, the media scanning device may control the scanning period according to at least one condition among a processing log of an application related to generation, change, and deletion of the media file, a media file transmission log with respect to another terminal, a download log of the media file through an external service, a total capacity of the internal storage medium, and a number of directories of the internal storage medium.

For example, when the processing log of the application related to generation, change, and deletion of the media file, the media file transmission log with respect to another terminal, or the download log of the media file through the external service is generated at least a control number of times, the media scanning device may control the scanning period to be short. In addition, when the total capacity of the internal storage medium is greater than a reference capacity or when the number of directories of the internal storage medium is greater than a control number, the scanning period may be controlled to be short.

As will be described, the media scanning device executes media scanning when the execution period of media scanning of the internal storage medium is longer than the scanning period. Therefore, the media scanning device may increase probability of executing media scanning by reducing the scanning period according to particular circumstances.

According to exemplary embodiments, to prevent problems that may occur to an internal.db file due to external factors applied to the user terminal, the media scanning device may check the internal.db file periodically to prevent the problem.

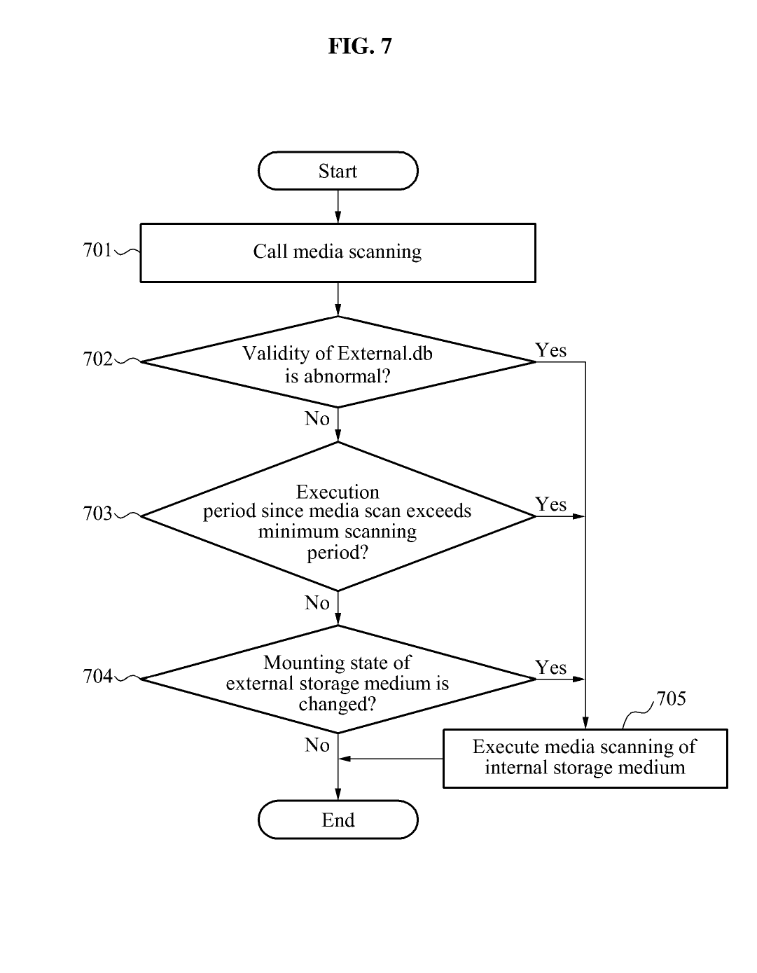

FIG. 7 is a diagram illustrating a process of determining necessity of media scanning for an external storage medium of a user terminal, according to exemplary embodiments of the present invention.

In operation 701, the media scanning device may call media scanning. In detail, the media scanning device may proceed with media scanning by calling media scanning.

In operation 702, the media scanning device may determine whether validity of External.db related to the internal storage medium is abnormal. In detail, the media scanning device may determine validity of the media file using a distinguishing value indicating a change state of a DB file related to the external storage medium and a generation date of the DB file related to the external storage medium. When the validity of the External.db is abnormal, the media scanning device may execute media scanning of the external storage medium in operation 705.

According to exemplary embodiments, when the validity of the External.db related to the internal storage medium is normal, the media scanning device may determine whether the execution period of media scanning exceeds a scanning period in operation 703. The execution period may refer to a difference between a current time at which booting is completed and a processing time of media scanning before booting.

When the execution period of media scanning exceeds the scanning period, the media scanning device may execute media scanning of the external storage medium in operation 705.

When a difference between a current date and a latest media scanning execution time is longer than the scanning period set by the user, the media scanning device may execute media scanning with respect to the entire region of the external storage medium. According to exemplary embodiments, the media scanning device may not execute media scanning when the difference between the current date and the latest date of executing media scanning is equal to or shorter than the scanning period.

That is, the media scanning device may execute media scanning when media scanning is necessary rather than every time booting is performed.

In addition, the media scanning device may control the scanning period according to at least one condition among an application processing log related to generation, change, and deletion of the media file, a media file transmission log with respect to another terminal, a download log of a media file through an external service, a total capacity of an external storage medium, and a number of directories of an external storage medium.

For example, when the application processing log related to generation, change, and deletion of the media file, the media file transmission log with respect to another terminal, or the download log of the media file through the external service is generated at least a control number of times, the media scanning device may control the scanning period to be short. Also, when the total capacity of the external storage medium is greater than a reference capacity or when the number of directories of the external storage medium is greater than a control number, the scanning period may be controlled to be short.

As will be described, the media scanning device executes media scanning when the execution period of media scanning of the external storage medium is longer than the scanning period. Therefore, the media scanning device may increase probability of executing media scanning by reducing the scanning period according to particular circumstances.

According to exemplary embodiments, when the execution period of media scanning is equal to or shorter than the scanning period, the media scanning device may determine a change in the mounting state of the external storage medium in operation 704. When the external storage medium is not mounted before the booting but is mounted after the booting, or when the external storage medium is dismounted and then remounted after the booting, the media scanning device may determine the mounting state of the external storage medium to be changed.

When the mounting state of the external storage medium is determined to be changed, the media scanning device may execute media scanning with respect to the external storage medium in operation 705. When the mounting state is determined to be not changed, the media scanning device may be ended without executing media scanning.

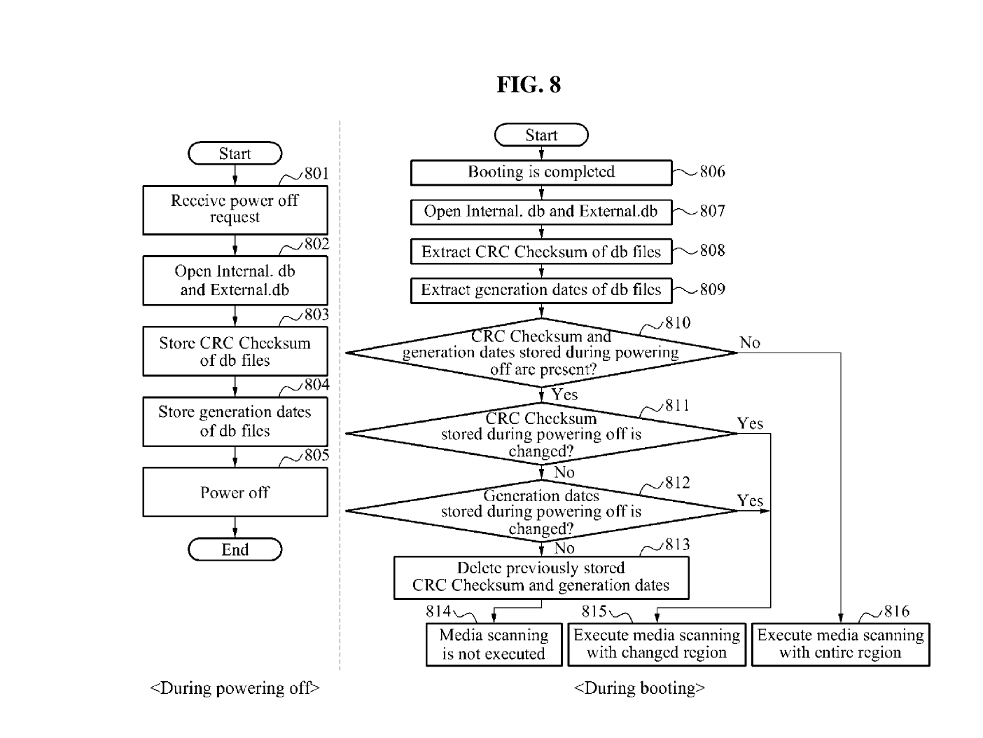

FIG. 8 is a diagram illustrating a process of determining validity of a media file, according to exemplary embodiments of the present invention.

Referring to FIG. 8, the process of when the user terminal is normally powered off is illustrated.

In operation 801, the user terminal may receive a power off request from the user. For example, a termination request or a reset request related to the user terminal may correspond to the power off request.

In operation 802, the user terminal may open internal.db related to a media file of the internal storage medium and external.db related to a media file of the external storage medium.

In operation 803, the user terminal may store CRC Checksum related to DB files. CRC Checksum refers to a distinguishing value indicating a change state of the DB files. CRC Checksum may be calculated with respect to media files of the internal storage medium and media files of the external storage medium through CRC 32 calculation API provided by, for example, JAVA. CRC Checksum may be determined based on a size, a number, and a structure or directory of the media files.

When a storing capacity of a total capacity of the internal storage medium is changed before and after the booting, the distinguishing value may be changed by a change in the storing capacity between before and after the booting. When the total number of files in the internal storage medium is changed before and after the booting, the distinguishing value may be changed by a changed number of the files. In addition, when the file structure is changed before and after the booting due to generation, name change, deletion, movement, and the like of folders in the internal storage medium of the user terminal, the distinguishing value may be changed by a number of changes of the file structure before and after the booting.

In operation 804, the user terminal may store generation dates of the DB files. Next, in operation 805, the user terminal may be normally powered off.

Booting may be performed after powering off the user terminal. In operation 806, booting of the user terminal may be completed.

In operation 807, the media scanning device may open Internal.db and External.db. In addition, in operation 808, the media scanning device may extract CRC Checksum of the DB files. In operation 809, the media scanning device may extract the generation dates of the DB files.

In operation 810, the media scanning device may determine whether the CRC Checksum and the generation dates of the DB files of the internal storage medium and the external storage medium stored at the time of powering off are present. When CRC Checksum and the generation dates of the DB files are absent, the media scanning device may execute media scanning with respect to the entire region of the internal storage medium and the external storage medium in operation 816.

When the CRC Checksum and the generation dates of the DB files are present, the media scanning device may determine whether CRC Checksum is changed before and after the booting in operation 811. When the CRC Checksum stored at the time of powering off is changed before and after the booting, the media scanning device may execute media scanning with respect to a changed part of CRC Checksum in the internal storage medium and the external storage medium in operation 816.

When a CRC Checksum has not changed, the media scanning device may determine whether the generation dates of the DB files are changed before and after booting in operation 812.

When the generation dates of the DB files of the internal storage medium and the external storage medium stored at the time of powering off are changed before and after booting, the media scanning device may execute partial media scanning with respect to a file of which the generation date is changed in operation 816.

According to exemplary embodiments, when the generation dates of the DB files are unchanged, the media scanning device may delete CRC Checksum and the generation dates of the DB files stored before booting.

Next, the media scanning device may not execute media scanning in operation 814.

That is, when necessity of media scanning is checked at the time of booting, the media scanning device may check whether a current DB file is changed, by comparing attributes of the current DB file stored during powering off before booting to attributes of the current DB file at the present or current time after booting.

When the attributes of the current DB file stored during powering off before booting is different from CRC Checksum or a generation date of the current DB file at the present or current time after booting, the media scanning device may execute partial media scanning with respect to a changed part.

FIG. 8 presumes that the user terminal is normally powered off. When a battery is separated from the user terminal or the user terminal is abnormally powered off due to full discharge of the battery, operations 801 to 805 are not performed. That is, when the user terminal is abnormally powered off, the user terminal may not store CRC Checksum and the generation date of the DB file.

Thus, when the user terminal is abnormally powered off, the user terminal may perform exclusive or extra processing during booting.

When the user terminal is abnormally powered off, the CRC Checksum and the generation date of the DB file, which are stored during powering off, are absent at the time of booting. Therefore, the user terminal may determine that powering off is performed abnormally and therefore execute media scanning with respect to the entire region of the internal storage medium and the external storage medium.

When the abnormal powering off occurs during booting, and when validity check routine of the media file is not performed, it is determined that the user terminal has not been normally booted. Therefore, the user terminal may perform normal booting afterward.

In addition, when abnormal powering off occurs during booting in a state in which validity check routine of the media file is normally performed, the media scanning device may delete a CRC check result and the generation date of the DB file, previously stored, and therefore may perform a control operation according to presence or absence of CRC check routine and the generation date.

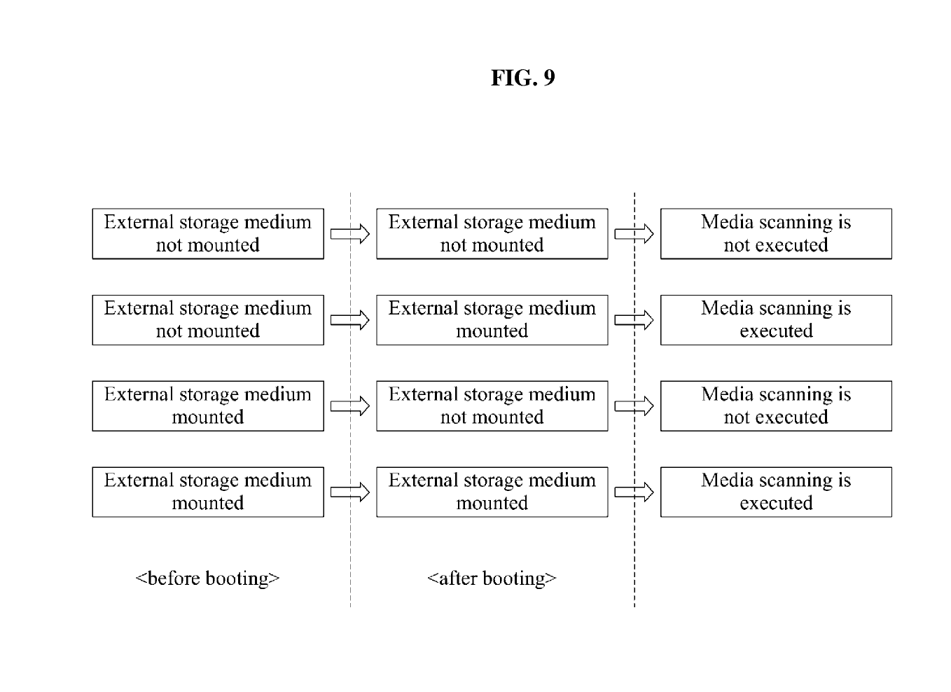

FIG. 9 is a diagram illustrating a process of executing media scanning according to a mounting state of an external storage medium, according to exemplary embodiments of the present invention.

According to exemplary embodiments, the media scanning device may check a current mounting state of the external storage medium and check whether the mounting state is changed before and after booting, to determine whether media scanning with respect to the external storage medium after booting is to be performed.

When the external storage medium is not mounted to the user terminal before booting and still not mounted to the user terminal even after booting, the media scanning device may not execute media scanning with respect to the external storage medium.

When the external storage medium is not mounted to the user terminal before booting but mounted after booting, the media scanning device may execute media scanning with respect to the external storage medium.

When the external storage medium is mounted to the user terminal before booting but not mounted after booting, the media scanning device may not execute media scanning with respect to the external storage medium.

In addition, when the external storage medium is separated after booting and then remounted, the media scanning device may execute media scanning with respect to the external storage medium.

When the external storage medium mounted to the user terminal before booting is different from the external storage medium mounted after booting, the media scanning device may execute media scanning with respect to the external storage medium mounted after booting.

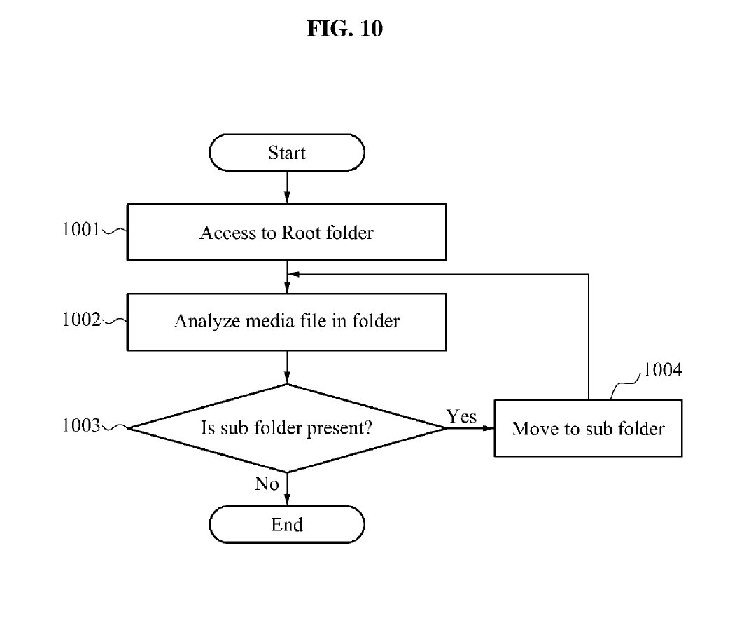

FIG. 10 is a diagram illustrating a process of media scanning according to exemplary embodiments of the present invention.

Referring to FIG. 10, in operation 1001, the media scanning device may access, for example, a Root folder of a storage medium with respect to which media scanning is to be executed.

In operation 1002, the media scanning device may analyze a media file in the Root folder. After the analyzing, the media scanning device may determine whether a sub folder is present in operation 1003.

When the sub folder is present, the media scanning device may move to the sub folder and repeat operation 1002 in operation 1004. When the sub folder is absent, the media scanning device may end media scanning.

That is, the media scanning device may execute media scanning with respect to a thumbnail or a cache by analyzing files to be media scanned in the internal storage medium or the external storage medium. The media scanning device may generate an internal.db and external.db as a result of media scanning. According to exemplary embodiments, when the CRC Checksum and the generation date of the DB file are changed, media scanning may be executed with respect to the changed part.

According to exemplary embodiments of the present invention, although the user terminal is booted, the media scanning device may execute media scanning not all the time but only when necessary by determining necessity of media scanning.

Here, the media scanning device may determine whether the state of the DB file is changed through the CRC checksum and the generation date of the DB file.

The media scanning device may execute media scanning with respect to the internal storage medium and the external storage medium, separately or jointly, as necessary, by determining whether the state of the DB file is changed.

Also, the media scanning device may determine the execution period of media scanning executed before booting, and execute media scanning to secure stability when media scanning is not executed within the scanning period.

That is, although the user terminal is booted, media scanning may be executed according to necessity of media scanning with respect to the internal storage medium and the external storage medium. Accordingly, the waiting time for the user may be reduced. Consequently, the boot time the user actually feels may be reduced.

According to exemplary embodiments of the present invention, media scanning is executed when media scanning is necessary after booting of a user terminal. Therefore, a boot time a user actually feels may be reduced.

In addition, according to exemplary embodiments of the present invention, a change state of a media file between before and after booting is determined and, accordingly, media scanning is executed with respect to the changed part. Accordingly, a processing time for media scanning may be effectively reduced.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A media scanning method comprises:
determining, when a terminal is booting, whether a storage medium of the terminal meets an execution condition for media scanning; and
performing media scanning of a storage medium when the determining determines that the execution condition for media scanning for the storage medium is met.

2. The method of claim 1, wherein the execution condition comprises a mounting state of the storage medium.

3. The method of claim 1, wherein the performing comprises updating a media library with information about media stored in the storage medium.

4. The method of claim 1, wherein the determining further comprises determining that a checksum or a generation date was not stored during a shutdown of the terminal that immediately preceded the booting.

5. The method of claim 1, further comprising:
receiving a power off request;
storing a checksum of the storage medium in a database; and
storing a generation date of the database.

6. The method of claim 5, wherein the determining further comprises determining that the checksum of the storage medium has changed since a shutdown of the terminal that immediately preceded the booting.

7. The method of claim 5, wherein the determining further comprises determining that the generation date has changed since a shutdown of the terminal that immediately preceded the booting.

8. The method of claim 1, wherein the determining further comprises determining that a scanning period for media scanning has elapsed.

9. The method of claim 8, wherein the scanning period is determined from one or more of a user input, a control value, or a condition.

10. The method of claim 9, wherein the condition comprises changes in one or more of an application processing log related to generation, change and deletion of a media file, a media file transmission log with respect to another terminal, a download log of the media file through an external service, a capacity of the internal storage medium, and a number of directories of the storage medium.

11. A media scanning terminal comprises:
an execution condition determination unit configured to determine, when a terminal is booting, whether a storage medium of the terminal meets an execution condition for media scanning; and
a media scanning unit configured to perform media scanning of the storage medium when the execution condition determination unit determines that the execution condition for media scanning for the storage medium is met.

12. The terminal of claim 11, wherein the execution condition determination unit comprises a mounting state check determination unit configured to determine a mounting state of the storage medium.

13. The terminal of claim 11, wherein media scanning unit is configured to update a media library with information about media stored in the storage medium.

14. The terminal of claim 11, wherein the execution condition determination unit comprises a validity determination unit configured to determine whether a checksum or a generation date was not stored during a shutdown of the terminal that immediately preceded the booting.

15. The terminal of claim 11, wherein the terminal is configured to receive a power off request, configured to store a checksum of the storage medium in a database, and configured to store a generation date of the database.

16. The terminal of claim 15, wherein the execution condition determination unit comprises a validity determination unit configured to determine whether the checksum of the storage medium has changed since a shutdown of the terminal that immediately preceded the booting.

17. The terminal of claim 15, wherein the execution condition determination unit comprises a validity determination unit configured to determine whether the generation date has changed since a shutdown of the terminal that immediately preceded the booting.

18. The terminal of claim 11, wherein the execution condition determination unit comprises an execution period check unit configured to determine whether a scanning period for media scanning has elapsed.

19. The terminal of claim 18, wherein the execution period check unit is configured to determine the scanning period from one or more of a user input, a control scanning period, or a condition.

20. The terminal of claim 19, wherein the scanning period is shortened when the condition comprises one or more of processing a log related to a media more than a control number of times, a capacity of the internal storage medium is greater than a control capacity, a number of directories on the storage medium is greater than a control directory number.
